(19) United States
(12) Patent Application Publication
(10) Pub. No.: US 2007/0256094 A1
(43) Pub. Date: Nov. 1, 2007

(54) Apparatus and Method for Distributing Signals by Down-Converting to Vacant Channels

(75) Inventors: Michael Anthony Pugel, Noblesville, IN (US); Douglas Edward Lankford, Carmel, IN (US); John Joseph Curtis III, Noblesville, IN (US); Keith Reynolds Wehmeyer, Fishers, IN (US); Mike Arthur Derrenberger, Valencia, CA (US); Terry Wayne Lockridge, Dayton, OH (US); Andrew Eric Bowyer, Indianapolis, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING, F-92100 BOULOGNE-BILLANCOURT FRANCE (FR)

(21) Appl. No.: 10/549,259

(22) PCT Filed: Mar. 9, 2004
(86) PCT No.: PCT/US04/07270

§ 371 Date: Mar. 15, 2007

(30) Foreign Application Priority Data
Mar. 11, 2003 (US) 60453,763
Mar. 11, 2003 (US) 60453491

(51) Int. Cl. H04N 7/10

(52) U.S. Cl. 725/34

(57) ABSTRACT

A gateway apparatus is capable of distributing signals such as audio, video, and/or data signals in a household and/or business dwelling using the existing coaxial cable infrastructure, and the signal distribution is controlled using the coaxial cable infrastructure as a back channel. According to an exemplary embodiment, the gateway apparatus includes signal processing elements for receiving signals from a broadcast source and processing the received signals to generate processed analog signals. A back channel demodulator receives a request signal from a client device via a coaxial cable connecting the gateway apparatus and the client device. The processed analog signals are provided to the client device via the coaxial cable responsive to the request signal.

### CROSS REFERENCE TO RELATED APPLICATION

This application claims priority to and all benefits accruing from two provisional applications filed in the United States Patent and Trademark Office on Mar. 11, 2003, and having respectively assigned Ser. Nos. 60/453,491 and 60/453,763.

### BACKGROUND OF THE INVENTION

1. Field of the Invention

The present invention generally relates to the distribution of signals such as audio, video and/or data signals, and more particularly, to an apparatus and method capable of distributing such signals in a household and/or business dwelling using the existing coaxial cable infrastructure, and controlling the signal distribution using the coaxial cable infrastructure as a back channel.

2. Background Information

In a satellite broadcast system, a satellite receives signals representing audio, video, and/or data information from an earth-based transmitter. The satellite amplifies and rebroadcasts these signals to a plurality of receivers, located at the dwellings of consumers, via transponders operating at specified frequencies and having given bandwidths. Such a system includes an uplink transmitting portion (i.e., earth to satellite), an earth-orbiting satellite receiving and transmitting portion, and a downlink portion (i.e., satellite to earth) including one or more receivers located at the dwellings of consumers.

For dwellings which receive signals via systems such as a satellite broadcast system, the distribution of received signals in the dwelling can be a difficult proposition. For example, many existing dwellings are equipped with coaxial cable such as RG-59 type coaxial cable, which is not readily conducive for distributing certain signals such as satellite broadcast signals. One reason coaxial cable such as RG-59 is not used to distribute such signals in a dwelling is that the coaxial cable may already be used for distributing cable broadcast signals. Accordingly, it may be difficult for signals such as satellite broadcast signals to co-exist with cable broadcast signals on the coaxial cable given its limited bandwidth. Another reason that coaxial cable such as RG-59 is not used to distribute certain signals in a dwelling is that the coaxial cable may use a portion of the frequency spectrum that is different than the frequencies occupied by the signals to be distributed. For example, signals such as satellite broadcast signals may occupy a portion of the frequency spectrum (e.g., greater than 1 GHz) which is higher than the signal frequencies that can be readily distributed over coaxial cable such as RG-59 and its associated signal splitters and/or repeaters (e.g., less than 860 MHz).

Heretofore, the issue of distributing, and controlling the distribution of, signals such as satellite broadcast signals in a dwelling using the existing coaxial cable infrastructure (e.g., RG-59) has not been adequately addressed. While certain technologies (e.g., IEEE 1394) may be used for signal distribution within a dwelling, such technologies typically require a dwelling to be re-wired, which may be cost-prohibitive for most consumers. Moreover, existing wireless technologies may not be suitable for distributing certain types of signals, such as video signals, within a dwelling.

Accordingly, there is a need for an apparatus and method, which avoids the foregoing problems, and thereby enables audio, video, and/or data signals to be distributed in a household and/or business dwelling using the existing coaxial cable infrastructure, and also controls the signal distribution using the coaxial cable infrastructure as a back channel.

### SUMMARY OF THE INVENTION

In accordance with an aspect of the present invention, a gateway apparatus is disclosed. According to an exemplary embodiment, the gateway apparatus comprises processing means for receiving signals from a broadcast source and processing the received signals to generate processed analog signals. Receiving means receive a request signal from a client device via a transmission medium, such as, a coaxial cable, connecting the gateway apparatus and the client device. The processed analog signals are provided to the client device via the transmission medium responsive to the request signal.

In accordance with another aspect of the present invention, a method for distributing signals from a gateway apparatus to a client device is disclosed. According to an exemplary embodiment, the method comprises steps of receiving signals from a broadcast source, receiving a request signal from the client device via a transmission medium, such as a coaxial cable, connecting the gateway apparatus and the client device, processing the received signals to generate processed analog signals, and providing the processed analog signals to the client device via the transmission medium responsive to the request signal.

In accordance with yet another aspect of the present invention, a client device is disclosed. According to an exemplary embodiment, the client device comprises a front-end processor operative to process analog signals provided from a gateway apparatus via a transmission medium, such as a coaxial cable, connecting the gateway apparatus and the client device. A back channel processor is operative to generate a request signal responsive to a user input. The request signal is provided to the gateway apparatus via the transmission medium and causes the gateway apparatus to provide the analog signals to the client device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of an exemplary environment suitable for implementing the present invention;

FIG. 2 is a block diagram of the gateway apparatus of FIG. 1 according to an exemplary embodiment of the present invention;

FIG. 3 is a diagram summarizing signal processing operations of the gateway apparatus of FIGS. 1 and 2 according to an exemplary embodiment of the present invention;

FIG. 4 is a block diagram of one of the client devices of FIG. 1 according to an exemplary embodiment of the present invention;

FIG. 5 is a flowchart illustrating steps according to one aspect of the present invention;

FIG. 6 is a flowchart illustrating steps according to another aspect of the present invention; and

FIG. 7 is a flowchart illustrating further details regarding one of the steps of FIG. 6 according to an exemplary embodiment of the present invention.

The exemplifications set out herein illustrate preferred embodiments of the invention, and such exemplifications are not to be construed as limiting the scope of the invention in any manner.

### DETAILED DESCRIPTION

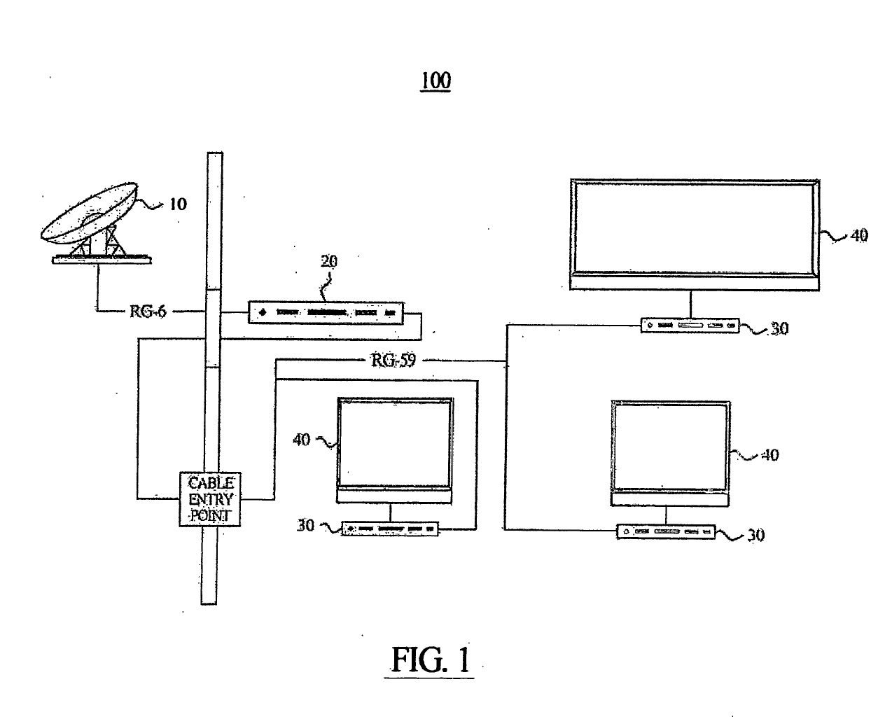

Referring now to the drawings, and more particularly to FIG. 1, a diagram of an exemplary environment 100 suitable for implementing the present invention is shown. In FIG. 1, environment 100 comprises a signal receiving element 10, a gateway apparatus 20, and client devices 30 each having an associated local output device 40. According to an exemplary embodiment, signal receiving element 10 is operatively coupled to gateway apparatus 20 via a coaxial cable connection comprised of RG-6 type coaxial cable, and gateway apparatus 20 is operatively coupled to each client device 30 via a coaxial cable connection comprised of RG-59 type coaxial cable. Other transmission media such as other types of coaxial cable, optical fibers, and air may also be used according to the present invention. Although not expressly shown in FIG. 1, environment 100 may also include elements such as signal splitters and/or repeaters. Environment 100 may for example represent a signal distribution network within a given household and/or business dwelling.

Signal receiving element 10 is operative to receive signals including audio, video, and/or data signals from one or more signal sources, such as a satellite broadcast system and/or other systems such as a digital terrestrial broadcast system. According to an exemplary embodiment, signal receiving element 10 is embodied as an antenna such as a satellite receiving dish, but may also be embodied as any type of signal receiving element such as an input terminal and/or other element.

Gateway apparatus 20 is operative to receive signals including audio, video, and/or data signals from signal receiving element 10, process the received signals to generate processed analog signals, and distribute the processed analog signals to client devices 30 via coaxial cable. According to an exemplary embodiment, each client device 30 is operative to receive and process the processed analog signals provided from gateway apparatus 20 to thereby enable corresponding aural and/or visual outputs via local output device 40. Each local output device 40 may be embodied as an analog and/or digital device such as a standard-definition (SD) and/or high-definition (HD) television signal receiver. Further exemplary details regarding client devices 30 will be provided later herein.

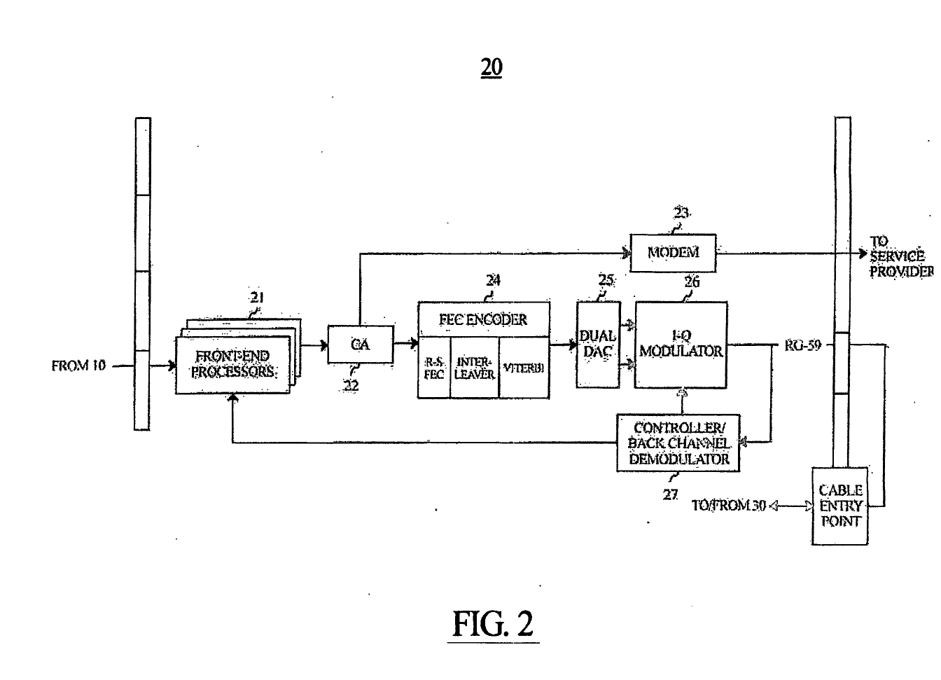

Referring to FIG. 2, a block diagram of gateway apparatus 20 of FIG. 1 according to an exemplary embodiment of the present invention is shown. In FIG. 2, gateway apparatus 20 comprises front-end processing means such as front-end processors 21, conditional access (CA) means such as CA module 22, modulating/demodulating means such as modem 23, encoding means such as forward error correction (FEC) encoder 24, digital-to-analog converting means such as dual digital-to-analog converter (DAC) 25, modulating means such as I-Q modulator 26, and controlling/demodulating means such as controller/back channel demodulator 27. The foregoing elements of FIG. 2 may be embodied using integrated circuits (ICs), and any given element may for example be included on one or more ICs. For clarity of description, certain conventional elements associated with gateway apparatus 20 such as certain control signals, power signals and/or other elements may not be shown in FIG. 2.

Front-end processors 21 are operative to perform various front-end processing functions of gateway apparatus 20. According to an exemplary embodiment, front-end processors 21 are each operative to perform processing functions including channel tuning, analog-to-digital (A/D) conversion, demodulation, FEC decoding, and de-multiplexing functions. As will be explained later herein, each front-end processor 21 may be controlled by a request signal provided from a corresponding client device 30 via the coaxial cable connecting gateway apparatus 20 and client devices 30. According to an exemplary embodiment, the channel tuning function of each front-end processor 21 may convert satellite broadcast signals from a relatively high frequency band (e.g., greater than 1 GHz) to baseband signals. As referred to herein, the term “baseband” may refer to signals, which are at, or near, a baseband level. The tuned baseband signals are converted to digital signals, which are demodulated to generate demodulated digital signals. According to an exemplary embodiment, each front-end processor 21 may be operative to demodulate various types of signals such as Quadrature Amplitude Modulated (QAM) signals, Phase Shift Keyed (PSK, e.g., QPSK) signals, and/or signals having other types of modulation. The FEC decoding function is applied to the demodulated digital signals to thereby generate error corrected digital signals. According to an exemplary embodiment, the FEC decoding function of each front-end processor 21 may include Reed-Solomon (R-S) FEC, de-interleaving, Viterbi and/or other functions. The error corrected digital signals from each front-end processor 21 may include a plurality of time-division multiplexed broadcast programs, and are de-multiplexed into one or more digital transport streams. For purposes of example and explanation, gateway apparatus 20 of FIG. 2 includes three front-end processors 21 (i.e., one for each client device 30). In practice, however, the number of front-end processors 21 may be a matter of design choice. For example, the number of front-end processors 21 may vary depending upon the number of coaxially connected client devices 30 serviced by gateway apparatus 20. Accordingly, there may be “N” front-end processors 21 for “N” client devices 30, where “N” is an integer.

CA module 22 is operative to perform a CA function of gateway apparatus 20 by decrypting the digital transport streams provided from front-end processors 21 to thereby generate decrypted digital transport streams. According to an exemplary embodiment, CA module 22 may include a smart card and/or other elements, which enable the CA function.

Modem 23 is operative to provide signals representing information such as billing, pay-per-view, and/or other information to a service provider. According to an exemplary embodiment, modem 23 may be coupled to a transmission medium such as a telephone line, and may be programmed to provide such information to the service provider in accordance with a predetermined schedule (e.g., every other Tuesday at 2:00 am, etc.).

FEC encoder 24 is operative to encode the decrypted digital transport streams provided from CA module 22 with error correction data to thereby generate encoded digital signals. According to an exemplary embodiment, FEC encoder 24 is operative to encode the decrypted digital transport streams by performing R-S FEC, data interleaving, Viterbi and/or other functions.

Dual DAC 25 is operative to convert the encoded digital signals provided from FEC encoder 24 to analog baseband signals. According to an exemplary embodiment, dual DAC 25 may generate the analog baseband signals as separate I (i.e., in-phase) and Q (i.e., quadrature) signals.

I-Q modulator 26 is operative to modulate the I and Q analog baseband signals provided from dual DAC 25 to thereby generate processed analog signals which may be provided to one or more client devices 30 via the coaxial cable connecting gateway apparatus 20 and client devices 30. I-Q modulator 26 may perform functions such as frequency upconversion, quadrature combining, filtering, and/or other functions. According to an exemplary embodiment, I-Q modulator 26 modulates the analog baseband signals responsive to one or more control signals provided from controller 27. Such control signals cause I-Q modulator 26 to modulate the analog baseband signals to one or more available frequency bands on the coaxial cable which may be used to provide the processed analog signals from gateway apparatus 20 to one or more client devices 30. According to an exemplary embodiment, I-Q modulator 26 modulates the analog baseband signals to radio frequency (RF) bands, which are less than 1 GHz.

According to an alternative embodiment, dual DAC 25 and I-Q modulator 26 may be replaced by a single DAC and an RF modulator (not shown in FIG. 2). With this alternative embodiment, an I-Q modulation function may be incorporated into FEC encoder 24 which would produce baseband encoded digital signals. The single DAC would convert the baseband encoded digital signals to analog signals. The RF modulator would then RF modulate the analog signals to one or more available frequency bands on the coaxial cable for delivery to one or more client devices 30.

Controller/back channel demodulator 27 is operative to perform control functions and back channel demodulation functions of gateway apparatus 20. According to an exemplary embodiment, controller 27 is operative to detect one or more available frequency bands on the coaxial cable, which may be used to provide the processed analog signals from gateway apparatus 20 to one or more client devices 30. Based on this detection, controller 27 generates one or more control signals, which control I-Q modulator 26, as previously described herein.

According to an exemplary embodiment, controller 27 dynamically scans a plurality of frequency bands on the coaxial cable to thereby detect the one or more available frequency bands. The controller 27 may detect an available frequency band by measuring the signal power in that frequency band. If the signal power of a frequency band is below a threshold indicating that no signal is transmitting in that frequency band, the controller 27 determines that the frequency band is available.

According to another exemplary embodiment, controller 27 may detect the one or more available frequency bands on the coaxial cable based on a user input. For example, a user may interact with gateway apparatus 20 via an on-screen UI provided via one or more client devices 30 which enables the user to select one or more frequency bands on the coaxial cable to be used for signal transmission between gateway apparatus 20 and client devices 30. In this manner, the user may cause certain frequency bands on the coaxial cable to be dedicated (i.e., “notched out”) for signal transmission between gateway apparatus 20 and client devices 30. Thus, as used herein the term “available frequency band” means either a frequency band detected by the controller 31 as having no signals transmitting or a frequency band specified by a user.

Also, according to an exemplary embodiment, back channel demodulator 27 is operative to receive and demodulate request signals provided from client devices 30 via the coaxial cable, which may be used as a back channel. Such request signals may control various functions of gateway apparatus 20, such as a channel tuning function. For example, demodulated request signals generated by back channel demodulator 27 may cause controller 27 to generate corresponding control signals that control the channel tuning function via front-end processors 21.

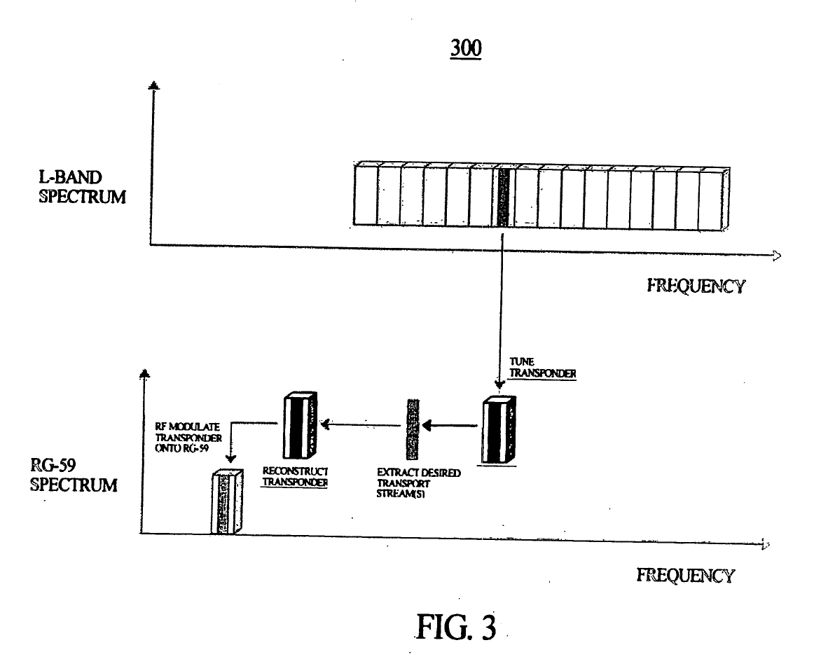

Referring to FIG. 3, a diagram 300 summarizing signal processing operations of gateway apparatus 20 according to an exemplary embodiment of the present invention is shown. In particular, diagram 300 illustrates the manner in which gateway apparatus 20 may process signals provided from a satellite broadcast system. As indicated in FIG. 3, gateway apparatus 20 first tunes a particular transponder. As previously indicated herein, one of the front-end processors 21 may perform a channel tuning function responsive to a request signal provided from a client device 30 via the coaxial cable, and thereby tune a channel corresponding to a particular transponder. One or more desired digital transport streams may then be extracted from the tuned channel corresponding to the particular transponder using the previously described analog-to-digital conversion, demodulation, FEC decoding, and de-multiplexing functions of one of the front-end processors 21. Next, signals for the particular transponder may be “reconstructed” by the encoding operations of FEC encoder 24 and the digital-to-analog conversions of DAC 25. Then, signals for the particular transponder may be RF modulated onto the RG-59 type coaxial cable so they may be distributed to one or more client devices 30.

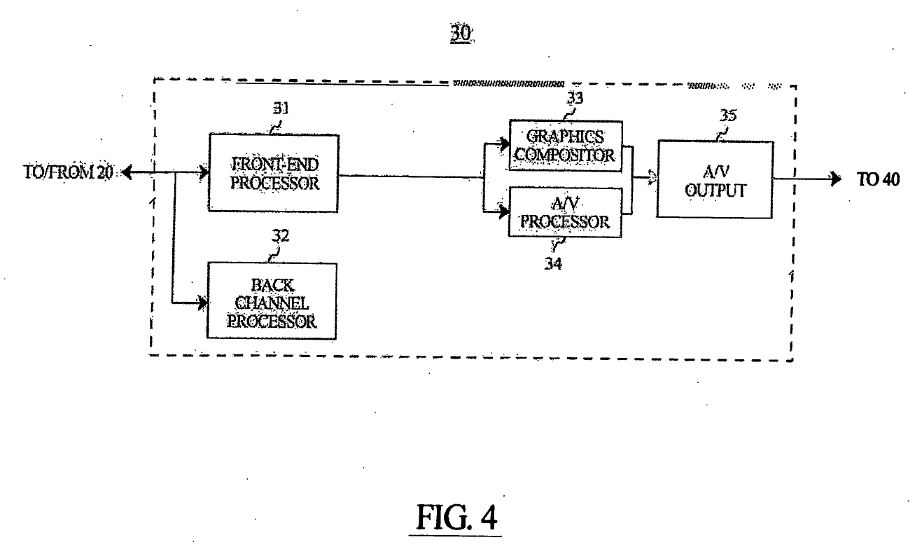

Referring to FIG. 4, a block diagram of one of the client devices 30 of FIG. 1 according to an exemplary embodiment of the present invention is shown. In FIG. 4, client device 30 comprises front-end processing means such as front-end processor 31, back channel processing means such as back channel processor 32, graphics compositing means such as graphics compositor 33, audio/video (A/V) processing means such as A/V processor 34, and A/V output means such as AN output 35. The foregoing elements of FIG. 4 may be embodied using ICs, and any given element may for example be included on one or more ICs. For clarity of description, certain conventional elements associated with client device 30 such as certain control signals, power signals and/or other elements may not be shown in FIG. 4.

Front-end processor 31 is operative to perform various front-end processing functions of client device 30. According to an exemplary embodiment, front-end processor 31 is operative to perform processing functions including channel tuning, A/D conversion, demodulation, FEC decoding, and de-multiplexing functions. According to an exemplary embodiment, the channel tuning function of front-end processor 31 converts the processed analog signals provided via the coaxial cable from gateway apparatus 20 to baseband signals. The tuned baseband signals are converted to digital signals, which are demodulated to generate demodulated digital signals. According to an exemplary embodiment, front-end processor 31 may be operative to demodulate various types of signals such as QAM signals, PSK (e.g., QPSIK) signals, and/or signals having other types of modulation. The FEC decoding function is applied to the demodulated digital signals to thereby generate error corrected digital signals. According to an exemplary embodiment, the FEC decoding function of front-end processor 31 may include R-S FEC, de-interleaving, Viterbi and/or other functions. The error corrected digital signals from front-end processor 31 may include a plurality of time-division multiplexed broadcast programs, and are de-multiplexed into one or more digital transport streams.

Back channel processor 32 is operative to perform various back channel processing functions of client device 30. According to an exemplary embodiment, back channel processor 32 is operative to generate request signals responsive to user inputs to client device 30, and such request signals may be used to control gateway apparatus 20. For example, back channel processor 32 may generate a request signal responsive to a channel change command to client device 30. A given request signal may include various types of information. According to an exemplary embodiment, the request signal includes information indicating one or more desired digital transport streams. In the event that gateway apparatus 20 is receiving signals from a satellite broadcast system, the request signal may also include information indicating a desired transponder, which provides the desired digital transport stream(s). Other information may also be included in the request signal. Also, according to an exemplary embodiment, back channel processor 32 is operative to detect one or more available frequency bands on the coaxial cable, which may be used to provide the request signals from client device 30 to gateway apparatus 20. According to an exemplary embodiment, back channel processor 32 may detect the one or more available frequency bands on the coaxial cable in the same manner as controller 27 of gateway apparatus 20. In particular, back channel processor 32 may dynamically scan a plurality of frequency bands on the coaxial cable to thereby detect the one or more available frequency bands, and/or may detect the one or more available frequency bands on the coaxial cable based on a user input, which selects the one or more available frequency bands.

According to a first exemplary embodiment, back channel processor 32 may also control the channel tuning function of front-end processor 31. For example, back channel processor 32 may include in a request to gateway apparatus 20 one of the available frequency bands it has dynamically detected or a frequency band selected by a user, and signal front-end processor 31 to tune that available frequency band or the frequency band selected by the user.

According to a second exemplary embodiment, back channel processor 32 may include all the available frequency bands in a request, and gateway apparatus 20 selects one of the available frequency bands to provide broadcast signals from a channel selected by a user. In the second exemplary embodiment, back channel processor 32 may dynamically scan a plurality of frequency bands on the coaxial cable after a request signal is provided to gateway apparatus 20 in order to detect a desired digital transport stream provided from gateway apparatus 20. According to this second exemplary embodiment, back channel processor 32 may process signals from the plurality of frequency bands to thereby detect a desired digital transport stream. For example, back channel processor 32 may detect program identification information in the signals from the plurality of frequency bands to thereby detect a desired digital transport stream. Once a desired digital transport stream is detected, back channel processor 32 may provide a control signal to front-end processor 31, which causes it to tune the particular frequency band on the coaxial cable that provides the desired digital transport stream.

In a third exemplary embodiment, back channel processor 32 does not include a frequency band in a request and gateway apparatus must detect an available frequency band to provide broadcast signals from a channel selected by the user. In this third exemplary embodiment, back channel should detect a desired digital transport stream and cause front-end processor 31 to tune the particular frequency band on the coaxial cable that provides the desired digital transport stream, as discussed above with respect to the second exemplary embodiment.

Graphics compositor 33 is operative to perform graphics compositing functions of client device 30, which enable graphical displays via local output device 40. According to an exemplary embodiment, graphics compositor 33 generates analog and/or digital signals, which represent graphical displays such as user interfaces (UIs), which allow users of local output device 40 to interact with client device 30 and/or gateway apparatus 20.

A/V processor 34 is operative to perform various A/V processing functions of client device 30. According to an exemplary embodiment, A/V processor 34 is operative to perform functions including Motion Picture Expert Group (MPEG) decoding, National Television Standards Committee (NTSC) or other type of encoding, and digital-to-analog (DIA) conversion functions. In this manner, the digital transport stream provided from front-end processor 31 may be MPEG decoded to generate decoded signals. The decoded signals may then be encoded as NTSC signals or other types of signals (e.g., PAL, SECAM, VSB, QAM, etc.), and converted to analog signals. In the event local output device 40 is a digital device such as a digital television signal receiver, the aforementioned encoding and/or D/A functions of A/V processor 34 may be bypassed.

A/V output 35 is operative to perform an A/V output function of client device 30 by enabling output of the analog and/or digital signals provided from graphics compositor 33 and/or A/V processor 34 to local output device 40. According to an exemplary embodiment, AN output 35 may be embodied as any type of A/V output means such as any type of wired and/or wireless output terminal.

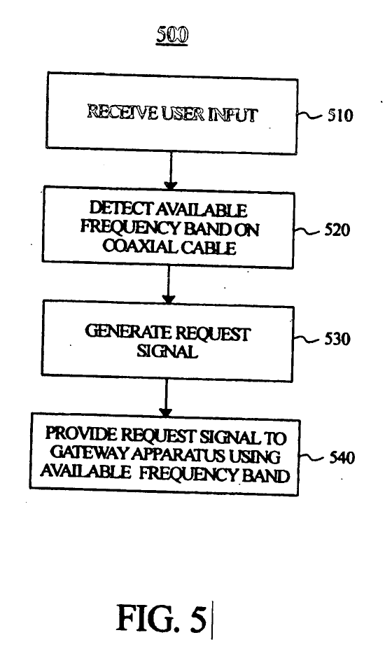

To facilitate a better understanding of the inventive concepts of the present invention, an example will now be provided. Referring to FIG. 5, a flowchart 500 illustrating steps according to one aspect of the present invention is shown. For purposes of example and explanation, the steps of FIG. 5 will also be described with reference to the previously described elements of environment 100 of FIG. 1. The steps of FIG. 5 are merely exemplary, and are not intended to limit the present invention in any manner.

At step 510, client device 30 receives a user input. According to an exemplary embodiment, the user input may be provided to client device 30 at step 510 through a user's interaction with a UI such as an electronic program guide (EPG) provided via a corresponding local output device 40. For example, a user of client device 30 may enter a command such as channel change command.

At step 520, client device 30 detects an available frequency band on the coaxial cable connecting it to gateway apparatus 20 responsive to the user input at step 510. As previously indicated herein, back channel processor 32 may dynamically scan a plurality of frequency bands on the coaxial cable to detect the available frequency band at step 520, and/or may detect the available frequency band based on a user input which selects the available frequency band.

At step 530, client device 30 generates a request signal responsive to the user input at step 510. According to an exemplary embodiment, back channel processor 32 generates the request signal, which may include various types of information such as information indicating one or more desired digital transport streams. As previously indicated herein, in the event that gateway apparatus 20 receives signals from a satellite broadcast system, the request signal may also include information indicating a desired transponder, which provides the desired digital transport stream(s).

At step 540, client device 30 provides the request signal to gateway apparatus 20 using the available frequency band on the coaxial cable detected at step 520. In this manner, the coaxial cable connecting gateway apparatus 20 and client devices 30 operates as a back channel to control signal distribution between gateway apparatus 20 and client device 30.

According to this embodiment, the gateway apparatus 20 should scan each frequency band to determine which frequency band is used as the back channel. The controller 27 in the gateway apparatus 20 may measure power in each frequency band. If the power is above a threshold, the controller 27 analyzes the signal to determine whether a back channel protocol is used and whether back channel information such as tuning commands is included in the signal. If both the back channel protocol is used and the channel information is included in the signal, the controller 27 determines that the frequency band has been selected as the backchannel by a client device.

In another embodiment, a frequency band, for example below 54 MHz, is pre-determined as the back channel. Each client device 30 is assigned a unique identifier, which is included in the request transmitted to the gateway apparatus 20. To avoid collision, each client device 30 should listen before transmit. A token scheme can be also used where the gateway apparatus 20 passes a token (with a timeout) to each client device so that a client device knows when it can transmit a request. Another way of avoiding collision is to use a timeslot scheme, where each client device 30 is allocated a fixed timeslot to transmit data in the back channel.

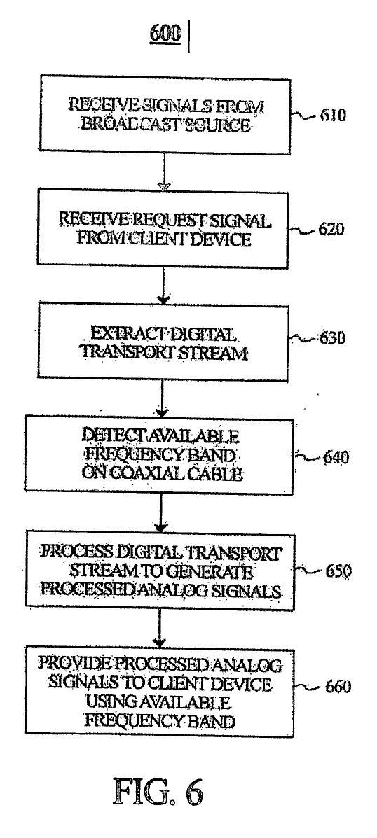

Referring to FIG. 6, a flowchart 600 illustrating steps according to another aspect of the present invention is shown. For purposes of example and explanation, the steps of FIG. 6 will also be described with reference to the previously described elements of environment 100 of FIG. 1. The steps of FIG. 6 are merely exemplary, and are not intended to limit the present invention in any manner.

At step 610, gateway apparatus 20 receives signals provided from a broadcast source. According to an exemplary embodiment, gateway apparatus 20 receives via signal receiving element 10 signals such as audio, video, and/or data signals from one or more signal sources, such as a satellite broadcast system and/or other systems such as a digital terrestrial broadcast system.

At step 620, gateway apparatus 20 receives the request signal from client device 30. As previously indicated herein, the request signal may be provided to gateway apparatus 20 via the coaxial cable connecting gateway apparatus 20 and client device 30 at step 540 of FIG. 5.

At step 630, gateway apparatus 20 extracts a desired digital transport stream from the received broadcast signals responsive to the request signal. According to an exemplary embodiment, back channel demodulator 27 demodulates the request signal and the resulting demodulated signal causes controller 27 to generate a corresponding control signal, which controls one of the front-end processors 21. Front-end processor 21 may then extract the desired digital transport stream at step 630 by performing the channel tuning, AND conversion, demodulation, FEC decoding, and de-multiplexing functions previously described herein.

At step 640, gateway apparatus 20 detects an available frequency band on the coaxial cable connecting it to client devices 30. As previously indicated herein, controller 27 may dynamically scan a plurality of frequency bands on the coaxial cable to detect the available frequency band at step 640, and/or may detect the available frequency band based on a user input which selects the available frequency band.

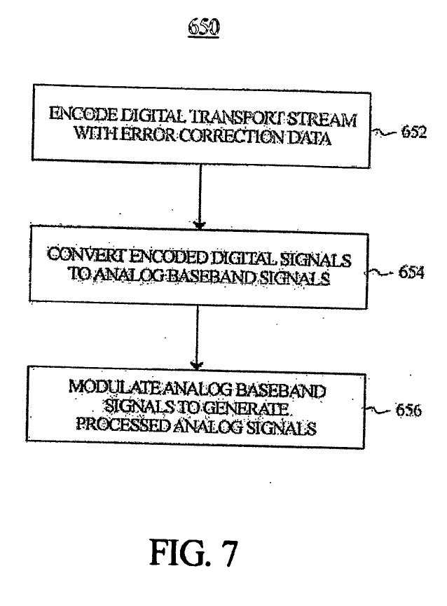

At step 650, gateway apparatus 20 processes the extracted digital transport stream to thereby generate processed analog signals. Referring to FIG. 7, further details regarding step 650 of FIG. 6 according to an exemplary embodiment of the present invention are provided. The details of FIG. 7 are merely exemplary, and are not intended to limit the present invention in any manner. As indicated in FIG. 7, step 650 of FIG. 6 includes sub-steps 652, 654 and 656.

At step 652, gateway apparatus 20 encodes the extracted digital transport stream with error correction data to thereby generate encoded digital signals. According to an exemplary embodiment, FEC encoder 24 encodes the extracted digital transport stream at step 652 by performing R-S FEC, data interleaving, Viterbi and/or other functions.

At step 654, gateway apparatus 20 converts the encoded digital signals to analog baseband signals. According to an exemplary embodiment, dual DAC 25 may generate the analog baseband signals as separate I (i.e., in-phase) and Q (i.e., quadrature) signals.

At step 656, gateway apparatus 20 modulates the analog baseband signals to thereby generate the processed analog signals. According to an exemplary embodiment, I-Q modulator 26 modulates the analog baseband signals to the available frequency band on the coaxial cable detected at step 640 responsive to one or more control signals provided from controller 27.

Referring back to FIG. 6, at step 660 gateway apparatus 20 provides the processed analog signals to client device 30 using the available frequency band on the coaxial cable detected at step 640. The steps of FIGS. 5 to 7 may be performed a plurality of times in a simultaneous manner to thereby simultaneously provide processed analog signals to “N” different client devices 30. In this manner, gateway apparatus 20 may for example distribute “N” different broadcast programs to “N” different client devices 30 in a simultaneous manner.

As described herein, the present invention provides an apparatus and method capable of distributing audio, video, and/or data signals in a household and/or business dwelling using the existing coaxial cable infrastructure, and controlling the signal distribution using the coaxial cable infrastructure as a back channel. The present invention may be applicable to various apparatuses, either with or without a display device. Accordingly, the phrase “television signal receiver” as used herein may refer to systems or apparatuses including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus, comprising:
processing means for receiving broadcast signals and processing said received signals to generate processed analog signals;
receiving means for receiving a request signal from a device via a transmission medium connecting said apparatus and said device, wherein said processed analog signals are provided to said device via said transmission medium responsive to said request signal, further wherein said request signal specifies a desired processed analog signal by identifying a program; and
control means for detecting an available frequency band on said transmission medium, wherein said available frequency band is used to provide said processed analog signals to said device, thereby causing said transmission medium to be shared between said processed analog signals and cable broadcast signals distributed over said transmission medium.

2. The apparatus of claim 1, wherein said transmission medium includes RG-59 cable.

3. The apparatus of claim 1, wherein said broadcast signals are transmitted from a satellite source.

4. The apparatus of claim 1, wherein said broadcast signals are transmitted from a digital terrestrial source.

5. The apparatus of claim 1, wherein said control means scans a plurality of frequency bands on said transmission medium to detect said available frequency band.

6. The apparatus of claim 1, wherein said control means detects said available frequency band based on a user input which selects said available frequency band.

7. The apparatus of claim 1, wherein said processing means comprises front-end processing means for extracting a desired digital transport stream from said received signals responsive to said request signal.

8. The apparatus of claim 8, wherein said processing means further comprises:
encoding means for encoding said desired digital transport stream with error correction data to generate encoded digital signals;
digital-to-analog converting means for converting said encoded digital signals to analog baseband signals; and
modulating means for modulating said analog baseband signals to generate said processed analog signals.

9. The apparatus of claim 1, wherein said receiving means comprises demodulating means for demodulating said request signal.

10. A method for distributing signals from a gateway apparatus to a client device, comprising steps of:
receiving broadcast signals from a broadcast source;
receiving a request signal from said client device via a transmission medium connecting said gateway apparatus and said client device, said request signal indicative of a desired digital transport stream;
processing said received signals to generate processed analog signals;
detecting an available frequency band on said transmission medium, wherein said available frequency band is used to provide said processed analog signals to said client device; and
providing said processed analog signals to said client device via said transmission medium responsive to said request signal, thereby causing said transmission medium to be shared between said processed analog signals and cable broadcast signals distributed over said transmission medium, wherein said request signal specifies a desired processed analog signal by identifying a program.

11. The method of claim 10, wherein said transmission medium includes RG-59 cable.

12. The method of claim 10, wherein said broadcast signals are transmitted from a satellite source.

13. The method of claim 10, wherein said broadcast signals are transmitted from a digital terrestrial source.

14. The method of claim 10, wherein said detecting step includes scanning a plurality of frequency bands on said transmission medium to identify said available frequency band.

15. The method of claim 10, wherein said detecting step is performed based on a user input which selects said available frequency band.

16. The method of claim 10, further comprising steps of:
extracting a desired digital transport stream from said received signals responsive to said request signal;
encoding said desired digital transport stream with error correction data to generate encoded digital signals;
converting said encoded digital signals to analog baseband signals; and
modulating said analog baseband signals to generate said processed analog signals.

17. A client device, comprising:
a front-end processor operative to process analog signals provided from an apparatus via a transmission medium connecting said apparatus and said client device;
a back channel processor operative to generate a request signal responsive to a user input, wherein said request signal is provided to said apparatus via said transmission medium and causes said apparatus to provide said processed analog signals to said client device, further wherein said request signal specifies a desired processed analog signal by identifying a program; and
control means for detecting an available frequency band on said transmission medium, wherein said available frequency band is used to provide said processed analog signals to said device, thereby causing said transmission medium to be shared between said processed analog signals and cable broadcast signals distributed over said transmission medium.

18. The client device of claim 17, wherein said transmission medium includes RG-59 cable.

19. The client device of claim 17, wherein:
said front-end processor processes said analog signals to generate a digital transport stream, and further comprising:
an A/V processor operative to process said digital transport stream to generate output signals.

20. The client device of claim 19, wherein said back channel processor scans a plurality of frequency bands on said transmission medium to detect said available frequency band.

21. The client device of claim 19, wherein said back channel processor detects said available frequency band based on a user input which selects said available frequency band.

22. A gateway apparatus, comprising:
a front-end processor operative to receive signals from a broadcast source and process said received signals to extract a desired digital transport stream;
an encoder operative to encode said desired digital transport stream with error correction data to generate encoded digital signals;
a digital-to-analog converter operative to convert said encoded digital signals to analog baseband signals;
a modulator operative to modulate said analog baseband signals to generate processed analog signals, wherein said processed analog signals are provided to a client device via a coaxial cable connecting said gateway apparatus and said client device, further wherein said client device requests a desired processed analog signal by identifying a program; and
a controller operative to detect an available frequency band on said coaxial cable, wherein said available frequency band is used to provide said processed analog signals to said client device, thereby causing said coaxial cable to be shared between said processed analog signals and cable broadcast signals distributed over said coaxial cable.

23. The gateway apparatus of claim 22, wherein said coaxial cable includes RG-59 cable.

24. The gateway apparatus of claim 22, wherein said broadcast source includes a satellite source.

25. The gateway apparatus of claim 22, wherein said broadcast source includes a digital terrestrial source.

26. The gateway apparatus of claim 22, wherein said controller scans a plurality of frequency bands on said coaxial cable to detect said available frequency band.

27. The gateway apparatus of claim 22, wherein said controller detects said available frequency band based on a user input which selects said available frequency band.

28. The gateway apparatus of claim 22, wherein said front-end processor extracts said desired digital transport stream responsive to said request by said client device provided to said gateway apparatus via said coaxial cable.

29. The apparatus according to claim 1, wherein said apparatus is a gateway apparatus.

30. The apparatus according to claim 1, wherein said processing means further comprises:
first processing means for receiving broadcast signals and processing said received broadcast signals to extract a desired digital transport stream; and
second processing means for processing said desired digital transport stream to generate said processed analog signals.
